(19) United States
(12) Patent Application Publication
(10) Pub. No.: US 2024/0378017 A1
(43) Pub. Date: Nov. 14, 2024

(54) ROUNDING IN FLOATING POINT ARITHMETIC

(71) Applicant: Arm limited, Cambridge (GB)

(72) Inventor: Olof Henrik Uhrenholt, Lomma (SE)

(73) Assignee: Arm Limited, Cambridge (GB)

(21) Appl. No.: 18/442,909

(22) Filed: Feb. 15, 2024

(30) Foreign Application Priority Data
May 11, 2023 (GB) 2306940.4

(51) Int. Cl. G06F 7/483

(52) U.S. Cl. CPC G06F 7/483

(57) ABSTRACT

An apparatus, a computer-readable medium, a system, a chip-containing product and a method are provided relating to floating point arithmetic, wherein a combined arithmetic operation with respect to three input floating point values is performed. The combined arithmetic operation comprises a rounded first arithmetic operation on the first and second input floating point values generating a rounded first arithmetic result and a rounded second arithmetic operation on the rounded first arithmetic result and the third input floating point value to generate a final rounded result of the combined arithmetic operation. When a shift operation on a non-zero mantissa of the third input floating point value generates a zero-value shifted mantissa, the zero-value shifted mantissa is adjusted to become non-zero.

The present techniques relate to data processing and in particular to a data processing apparatus performing floating point arithmetic.

A data processing apparatus which performs floating point arithmetic can be required to perform a variety of arithmetic operations on floating point values. Further, some arithmetic operations are commonly performed in association with one another, such as a multiply-add operation, whereby two operands are first multiplied together, and then a third operand is added to the result of the multiplication operation. In addition, when performing arithmetic operations on floating point values, it is often necessary to round a result value when the result value is constrained to be provided within a predefined number of bits. Some data processing apparatuses may be provided with circuitry which is dedicated to performing a fused multiply-add (FMA) operation on floating point values, whereby the multiplication and addition operations on the three input values are performed in a first step, before the final result value is rounded. An FMA unit nevertheless will occupy a significant portion of area in a data processor and its provision must therefore be justified with reference to the frequency with which it will be used and the area and power it will consume. As an alternative, a chained multiply-add (CMA) unit may be provided, which saves area and power by being a simpler configuration, yet this approach will perform the arithmetic operation slightly differently, by generating a rounded multiplication result of the first two operands, then summing this with the third operand, and finally rounding the end result. This can result is small differences in the end result, due to the different approach to the rounding.

At least some examples provide an apparatus comprising:

floating point arithmetic circuitry configured to perform a combined arithmetic operation with respect to a first input floating point value, a second input floating point value, and a third input floating point value,

wherein the combined arithmetic operation comprises:

a rounded first arithmetic operation on the first input floating point value and the second input floating point value to generate a rounded first arithmetic result; and

a rounded second arithmetic operation on the rounded first arithmetic result and the third input floating point value to generate a final rounded result of the combined arithmetic operation,

wherein, when the combined arithmetic operation is first arithmetic operation dominated, the floating point arithmetic circuitry is configured to perform a shift operation on a mantissa of the third input floating point value based on an exponent difference between summed exponents of the first and second input floating point values and an exponent of the third input floating point value,

wherein the floating point arithmetic circuitry further comprises sticky-bit preservation circuitry configured to apply a sticky-bit preservation to the shift operation, wherein the sticky-bit preservation comprises:

for a non-zero mantissa of the third input floating point value, when the shift operation on the mantissa of the third input floating point value generates a zero-value shifted mantissa, adjusting the zero-value shifted mantissa to become non-zero.

At least some examples provide a non-transitory computer-readable medium on which is stored computer-readable code for fabrication of an apparatus as set out above.

At least some examples provide a method of operating floating point arithmetic circuitry comprising:

performing a combined arithmetic operation with respect to a first input floating point value, a second input floating point value, and a third input floating point value, wherein the combined arithmetic operation comprises:

performing a rounded first arithmetic operation on the first input floating point value and the second input floating point value to generate a rounded first arithmetic result;

performing a rounded second arithmetic operation on the rounded first arithmetic result and the third input floating point value to generate a final rounded result of the combined arithmetic operation;

when the combined arithmetic operation is first arithmetic operation dominated, performing a shift operation on a mantissa of the third input floating point value based on an exponent difference between summed exponents of the first and second input floating point values and an exponent of the third input floating point value; and

applying a sticky-bit preservation to the shift operation, wherein the sticky-bit preservation comprises:

for a non-zero mantissa of the third input floating point value, when the shift operation on the mantissa of the third input floating point value generates a zero-value shifted mantissa, adjusting the zero-value shifted mantissa to become non-zero.

The present techniques will be described further, by way of example only, with reference to embodiments thereof as illustrated in the accompanying drawings, to be read in conjunction with the following description, in which:

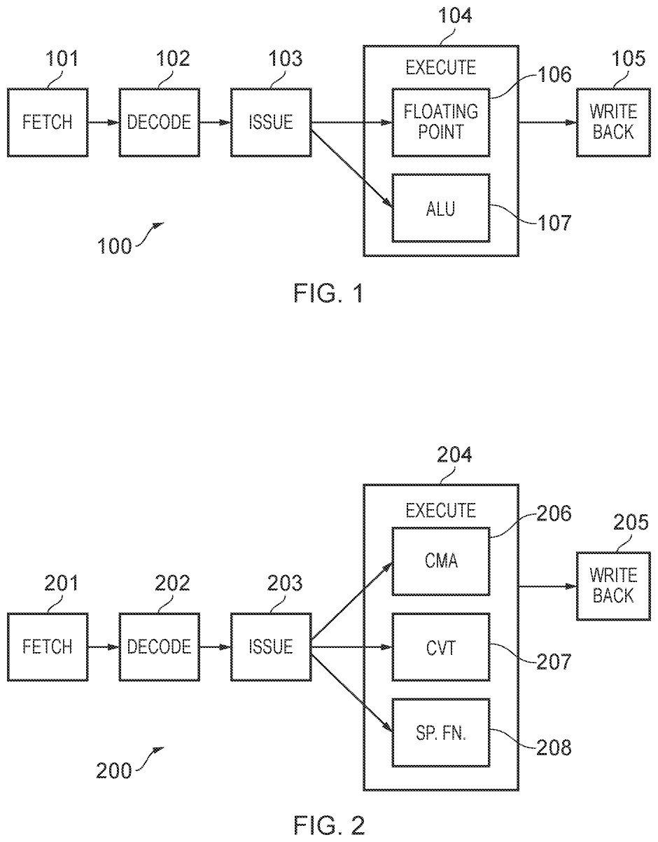

FIG. 1 schematically illustrates an apparatus comprising floating point arithmetic circuitry in accordance with some examples;

FIG. 2 schematically illustrates an apparatus comprising floating point arithmetic circuitry in accordance with some examples;

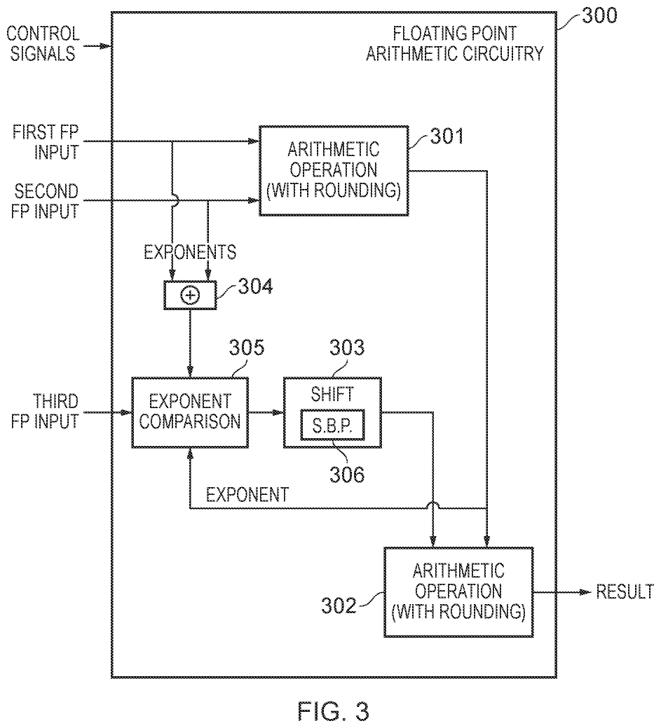

FIG. 3 schematically illustrates floating point arithmetic circuitry in accordance with some examples;

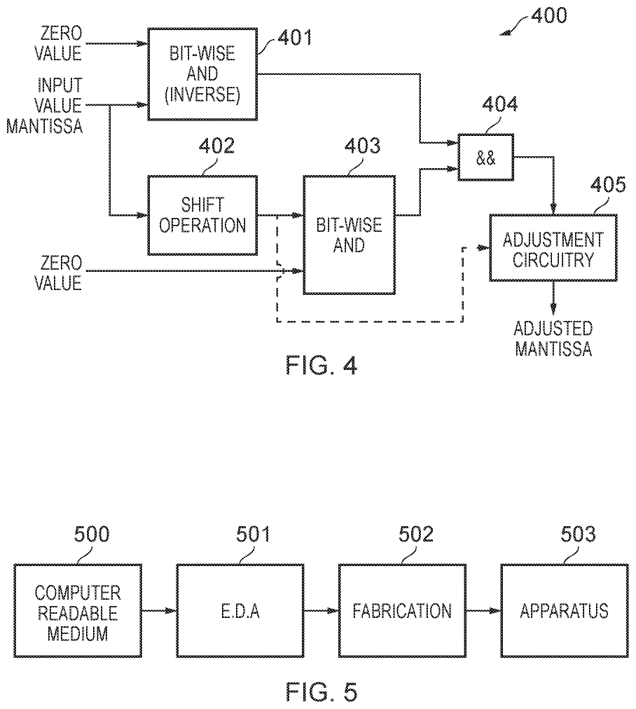

FIG. 4 schematically illustrates sticky-bit preservation circuitry in accordance with some examples;

FIG. 5 schematically illustrates a process of fabrication of an apparatus comprising floating point arithmetic circuitry in accordance with some examples;

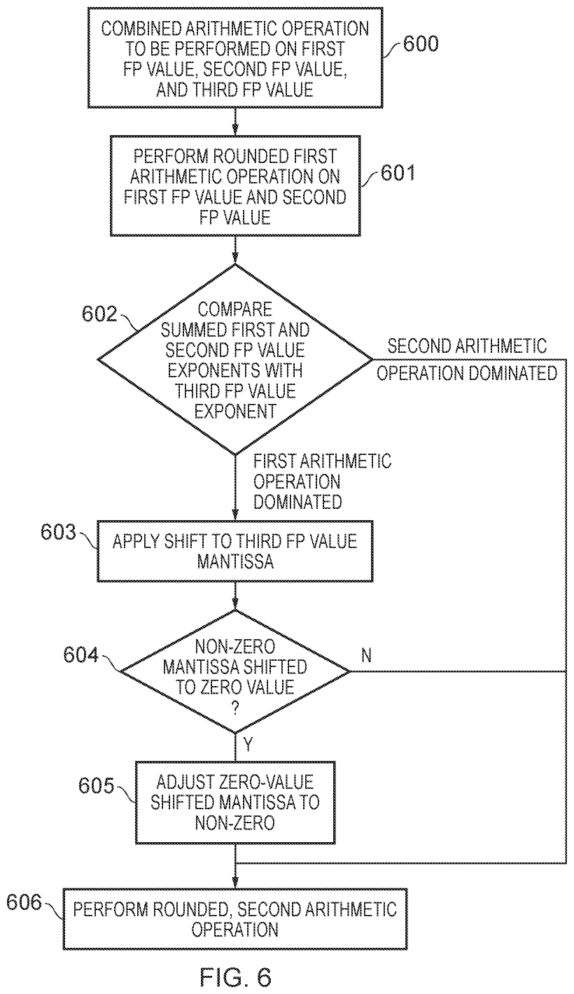

FIG. 6 is a flow diagram showing a sequence of steps which are taken when carrying out a method in accordance with some examples; and

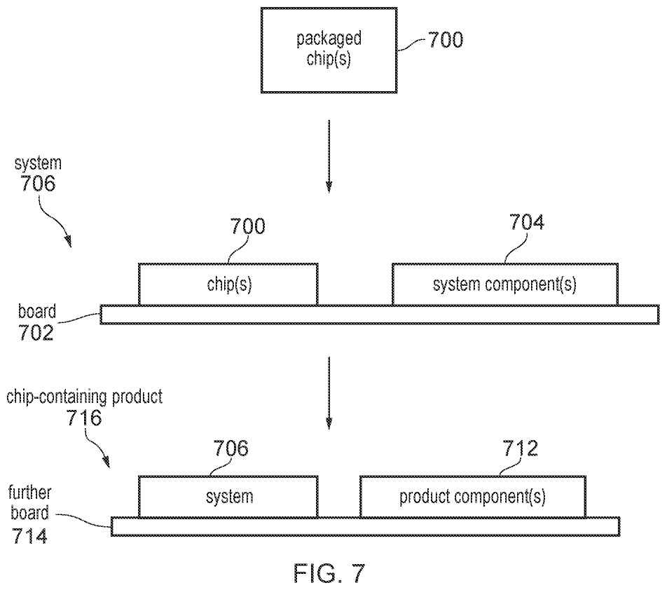

FIG. 7 schematically illustrates examples of the apparatus or circuitry being embodied in a system comprising at least one packaged chip or in a chip-containing product comprising at least one such system.

In one example herein there is an apparatus comprising:

floating point arithmetic circuitry configured to perform a combined arithmetic operation with respect to a first input floating point value, a second input floating point value, and a third input floating point value,

wherein the combined arithmetic operation comprises:

a rounded first arithmetic operation on the first input floating point value and the second input floating point value to generate a rounded first arithmetic result; and

a rounded second arithmetic operation on the rounded first arithmetic result and the third input floating point value to generate a final rounded result of the combined arithmetic operation,

wherein, when the combined arithmetic operation is first arithmetic operation dominated, the floating point arithmetic circuitry is configured to perform a shift operation on a mantissa of the third input floating point value based on an exponent difference between summed exponents of the first and second input floating point values and an exponent of the third input floating point value,

wherein the floating point arithmetic circuitry further comprises sticky-bit preservation circuitry configured to apply a sticky-bit preservation to the shift operation, wherein the sticky-bit preservation comprises:

for a non-zero mantissa of the third input floating point value, when the shift operation on the mantissa of the third input floating point value generates a zero-value shifted mantissa, adjusting the zero-value shifted mantissa to become non-zero.

The inventor of the present techniques has identified a particular aspect of a floating point combined arithmetic operation, when performed in two distinct steps of a rounded first arithmetic operation and a rounded second arithmetic operation, whereby the possibility arises for a rounding difference to occur when compared with the result of a single step fused operation. Specifically, this happens when the necessity arises to shift the mantissa of the third input floating point value such that it is appropriately lined up with the result of the first operation on the first input floating point value and the second input floating point value. In examples where the first operation result dominates (i.e. is larger in exponent terms than) the third input floating point, it has been found that the shift applied to the mantissa of the third input floating point value can be so large (i.e. for relatively small third input floating point values) as to exclude a sticky bit forming part of the third input floating point value mantissa. The exclusion of this sticky bit would then mean that the final rounding step applied would result in a slightly different result value than if the operation had been carried out as a fused operation with a single rounding step. In the absence of the present techniques, several additional steps would typically be required to ensure that the correctly rounded final result is produced, where these steps include clamping the shift to a maximum shift which can be allowed (i.e. that preserves a sticky bit when applied to a mantissa with the smallest subnormal that is supported). However the inventor of the present techniques has realised that it is also possible to address this issue, and thus to allow a result value to be generated with is directly equivalent to that which would be produced by a fused operation, but without needing to provide dedicated fused circuitry, and without the additional shift-clamping steps mentioned as being otherwise required. The proposal of the present techniques is that a “sticky-bit preservation” can be applied to the shift operation, wherein the sticky-bit preservation comprises identifying cases where (for a non-zero mantissa of the third input floating point value) the shift operation on the mantissa of the third input floating point value would generate a zero-value shifted mantissa, and in such cases adjusting the zero-value shifted mantissa to become non-zero. This adjustment allows a sticky bit in the mantissa, which would otherwise have been excluded by the shift, effectively to be preserved, and hence for the final rounding to generate the required result.

The “sticky-bit preservation” may be carried out in a number of ways, but in some examples sticky-bit preservation circuitry configured to do so is provided, wherein the sticky-bit preservation circuitry comprises:

bit-wise-AND circuitry configured to determine whether the mantissa of the third input floating point value is a non-zero value;

bit-wise-AND circuitry configured to determine whether the shift operation on the mantissa of the third input floating point value generates a zero value; and

output adjustment circuitry configured to adjust the zero-value shifted mantissa to become non-zero.

Bit-wise AND circuitry can be provided with only limited hardware expense, and thus this approach can be implemented with only a modest area requirement.

The output adjustment circuitry may adjust the zero-value shifted mantissa to become non-zero in a number of ways, but in some examples the output adjustment circuitry is configured to increment the zero-value shifted mantissa.

The combined arithmetic operation may take various forms, but in some examples the combined arithmetic operation is a chained multiply-add operation,

wherein the rounded first arithmetic operation is a rounded multiplication, and

wherein the rounded second arithmetic operation is a rounded addition.

The present techniques further recognise that such floating point operations may be invoked by defined instructions forming part of an instruction set architecture, and hence it is further envisaged that a sticky-bit-preserving shift instruction is added to such an instruction set. Accordingly, some examples further comprise:

instruction decoding circuitry configured to decode program instructions and to generate control signals to control the floating point arithmetic circuitry to perform floating point arithmetic operations represented by the program instructions,

wherein the instruction decoding circuitry is configured to decode a sticky-bit-preserving shift instruction and to generate control signals which cause the sticky-bit preservation circuitry to apply the sticky-bit preservation to the shift operation.

In one example herein there is a non-transitory computer-readable medium on which is stored computer-readable code for fabrication of an apparatus as defined in any of the examples given.

In one example herein there is a method of operating floating point arithmetic circuitry comprising:

performing a combined arithmetic operation with respect to a first input floating point value, a second input floating point value, and a third input floating point value, wherein the combined arithmetic operation comprises:

performing a rounded first arithmetic operation on the first input floating point value and the second input floating point value to generate a rounded first arithmetic result;

performing a rounded second arithmetic operation on the rounded first arithmetic result and the third input floating point value to generate a final rounded result of the combined arithmetic operation;

when the combined arithmetic operation is first arithmetic operation dominated, performing a shift operation on a mantissa of the third input floating point value based on an exponent difference between summed exponents of the first and second input floating point values and an exponent of the third input floating point value; and

applying a sticky-bit preservation to the shift operation, wherein the sticky-bit preservation comprises:

for a non-zero mantissa of the third input floating point value, when the shift operation on the mantissa of the third input floating point value generates a zero-value shifted mantissa, adjusting the zero-value shifted mantissa to become non-zero.

In some examples, the sticky-bit preservation comprises:

using bit-wise-AND circuitry to determine whether the mantissa of the third input floating point value is a non-zero value;

using bit-wise-AND circuitry to determine whether the shift operation on the mantissa of the third input floating point value generates a zero value.

In some examples, adjusting the zero-value shifted mantissa comprises incrementing the zero-value shifted mantissa.

In some examples, the combined arithmetic operation is a chained multiply-add operation,

wherein the rounded first arithmetic operation is a rounded multiplication, and

wherein the rounded second arithmetic operation is a rounded addition.

In some examples, the method further comprises:

using instruction decoding circuitry to decode program instructions and to generate control signals to control floating point arithmetic circuitry to perform floating point arithmetic operations represented by the program instructions,

wherein decoding the program instructions comprises decoding a sticky-bit-preserving shift instruction and generating control signals which cause the application of the sticky-bit preservation to the shift operation.

Some particular embodiments are now described with reference to the figures.

FIG. 1 schematically illustrates a data processing apparatus 100 in accordance with some examples. The data processing apparatus 100 has a generally pipeline-based configuration, of which the general principles will be familiar to one of ordinary skill in the art. Only a rather high level schematic representation is shown here for the purposes of providing broad context for this disclosure. The pipeline stages illustrated are a fetch stage 101, the decode stage 102, an issue stage 103, an execute stage 104, and a write-back stage 105. Data processing instructions provide to define the data processing operations which should be carried out by the data processing apparatus 100 are retrieved by the fetch stage 101 from memory (and typically via an intervening cache hierarchy). Each instruction is passed in turn to the decode stage 102, which is configured to decode program instructions and to generate control signals to control the remainder of the data processing apparatus 100 to perform the defined data processing operations represented by the program instructions. Decoded instructions pass to the issue stage 103, which queues decoded instructions (or micro-ops derived therefrom), issuing these to the corresponding execution unit when it is available and when, for examples, values which are required for the defined operation to be carried out have become available in registers (not explicitly illustrated). In the example of FIG. 1, two execution units are shown, namely a floating point unit 106 and an arithmetic logic unit 107. The floating point unit 106 is configured to carry out floating point operations on floating point values, whilst the arithmetic logic unit is configured to carry out other arithmetic and logic operations on fixed point (e.g. integer) values. The floating point unit 106 is configured to perform combined arithmetic operations with respect to three input floating point values, whereby a first arithmetic operation is performed on the first input floating point value and the second input floating point value to generate a rounded first arithmetic result, followed by a second arithmetic operation on the rounded first arithmetic result and the third input floating value to generate a final rounded result of the combined arithmetic operation. As will be described in more detail with reference to the further figures, the second arithmetic operation may involve a shift operation and the floating point unit 106 is arrange to be capable of applying a sticky-bit preservation to the shift operation.

FIG. 2 schematically illustrates a data processing apparatus 200 in accordance with some examples, which is generally similar to the apparatus 100 of FIG. 1. The data processing apparatus 200 also has a pipelined sequence of stages: the fetch stage 201, the decode stage 202, the issue stage 203, the execute stage 204, and the write-back stage 205. The execute stage 204 in the example of FIG. 2 comprises a chained multiply-add (CMA) unit 206, a convert (CVT) unit 207, and a special function (Sp.Fn.) unit 208. The issue stage issues operations to be performed to one of these execute units in dependence on the instruction type. As will be described in more detail with reference to the further figures, the CMA unit 206 can perform shift operations as part of the chained multiply-add operations it performs, and the CMA unit 206 is arrange to be capable of applying a sticky-bit preservation to the shift operation.

FIG. 3 schematically illustrates in more detail floating point arithmetic circuitry 300 in accordance with some examples. The floating point arithmetic circuitry 300 operates as dictated by control signals deriving from the decoding of instructions, specifically of instructions which specify floating point operations to be carried out. The floating point arithmetic circuitry is configured to receive three floating point input values and to perform a combined arithmetic operation with respect to those three input values. More particularly the combined arithmetic operation firstly comprises a rounded first arithmetic operation on the first input floating point value and the second input floating point value to generate a rounded first arithmetic result. Then the combined arithmetic operation further comprises a rounded second arithmetic operation on the rounded first arithmetic result and the third input floating point value to generate a final rounded result of the combined arithmetic operation. Arithmetic operation circuitry 301 performs the first arithmetic operation on the first and second floating point input values, with the result being rounded. Arithmetic operation circuitry 302 performs the second arithmetic operation on the third floating point input value and the result of the first arithmetic operation. In order to correctly align the third floating point input value and the result of the first arithmetic operation for this second arithmetic operation, a shift may be performed by shift circuitry 303. The extent of this shift is determined by a comparison of the respective components of the first, second, and third floating input values. For this purpose, exponent addition circuitry 304 is provided (to sum the exponents of the first and second floating point input values) and exponent comparison circuitry 305 compares this summed exponent with the exponent of the third floating input value. The size of the required shift is determined by this comparison and passed to the shift circuitry 303. The shift circuitry 303 is further provided with sticky-bit preservation circuitry 306, which is configured to impose a sticky-bit preservation on the shift operation. This is provides that a sticky bit in the mantissa, which would otherwise have been excluded by the shift, is preserved, and is hence present for the final rounding step carried out by the arithmetic operation circuitry 302. The final result generated is then correctly rounded (by comparison with a fused, single operation combining the three floating point input values), despite that arithmetic operations having been carried out in two steps. In some examples the rounded first arithmetic operation is a rounded multiplication and the rounded second arithmetic operation is a rounded addition.

An example code sequence by which a fused-multiply-add (FMA) can be provided using chained-multiply-add (CMA) hardware is shown below:

| | |
|---|---|
| 1 | // First normalize all input to avoid overflow and underflow in the |
| | rest of the sequence |
| 2 | %FREXPM.f32 m0, r0 |
| 3 | %FREXPE.f32 e0, r0 |
| 4 | %FREXPM.f32 m1, r1 |
| 5 | %FREXPE.f32 e1, r1 |
| 6 | %FREXPM.f32 m2, r2 |
| 7 | %FREXPE.f32 e2, r2 |
| 8 | %IADD e, e0, e1 |
| 9 | // Negative d is addend dominated. Positive d is multiply dominated |
| 10 | %ISUB d, e, e2 |
| 11 | // Determine final shift |
| 12 | %CSEL.s32.lt fs, d, k0, e2, e |
| 13 | // Clamp and shift one of the multiply operands |
| 14 | %CSEL.s32.lt d0, d, k0, d, k0 |
| 15 | *LDEXP.f32 m0, m0, d0 |
| 16 | // Clamp and shift the addend. Upper bound at 149 to provide a |
| | sticky bit for underflow of the addend |
| 17 | %CSEL.s32.gt d2, d, k0, d, k0 |
| 18 | %CSEL.s32.gt d2, d2, #149, #149, d2 |
| 19 | %ISUB d2, k0, d2 |
| 20 | *LDEXP.f32 m2, m2, d2 |
| 21 | // Veltkamp splitting of the multiply operands (error free transform) |
| 22 | %AND_IMM.i32 xh, m0, #0xFFFFF000 |
| 23 | *FADD.f32 xl, m0, xh.neg |
| 24 | %AND_IMM.i32 yh, m1, #0xFFFFF000 |
| 25 | *FADD.f32 yl, m1, yh.neg |
| 26 | // Dekker multiplication (error free transform) |
| 27 | *FMUL.f32 dr1, m0, m1 |
| 28 | *CMA.f32 dt1, xh, yh, dr1.neg |
| 29 | *CMA.f32 dt2, xh, yl, dt1 |
| 30 | *CMA.f32 dt3, xl, yh, dt2 |
| 31 | *CMA.f32 dr2, xl, yl, dt3 |
| 32 | // Fast 2sum (error free transform) |
| 33 | %CSEL.f32.le u0, m2.abs, dr1.abs, m2, dr1 |
| 34 | %CSEL.f32.le u1, m2.abs, dr1.abs, dr1, m2 |
| 35 | *FADD.f32 s, u0, u1 |
| 36 | *FADD.f32 z, s, u1.neg |
| 37 | *FADD.n_add.f32 t, u0, z.neg |
| 38 | // Add the 3 final terms |
| 39 | *FADD.f32.sticky v, t, dr2 |
| 40 | *FADD_RSCALE.f32.n r0, s, v, fs |

Of particular interest to the present disclosure are lines 18-20 of the code sequence, where at line 18 the required shift to be applied to the mantissa (m2) of the third floating point input value (r2) is determined and, if greater than 149 is capped at 149, this being the largest shift amount which will keep a sticky bit by not shifting so far as to remove the smallest subnormal (denormal) value supported. In other examples the shift cap would be modified according to the precision of the floating point values handled. The shift is applied at line 20. The present techniques provides an alternative approach to limiting the shift by providing hardware which can accelerate lines 18-20 of the above code. This approach provides a variant on the LDEXP instruction which behaves as shown in the following pseudo-code.

```
Sf32 LDEXP_STICKY(sf32 arg0, int arg1, roundmode rm)
{
  sf32 out = LDEXP(arg0, arg1, rm);
  out |= (arg0 & 0x7fffffff) && !(out & 0x7fffffff);
  return out;
}
```

Thus the LDEXP_STICKY function provides that the usual LDEXP function is applied to the floating point value arg0 to shift it by the integer number of positions arg1. When this arg0 is non-zero and the application of the LDEXP function results in a zero value, the returned result out is incremented to preserve a sticky bit in the least significant bit position.

FIG. 4 schematically illustrates sticky-bit preservation circuitry 400 in accordance with some examples. Here the circuitry is provided by inverse bit-wise AND circuitry 401, shift circuitry 402, bit-wise AND circuitry 403, logical AND circuitry 404, and adjustment circuitry 405. The two inputs of the inverse bit-wise AND circuitry 401 are a zero value and the mantissa of the subject floating point value. Thus, when the mantissa of the subject floating point value is non-zero, this generates a logical ‘1’ signal. The mantissa of the subject floating point value is subjected to the shift operation performed by the shift circuitry 402 and the output provides a first input to the bit-wise AND circuitry 403. The other input to the bit-wise AND circuitry 403 is a zero value. Thus, when the shifted mantissa of the subject floating point value is zero, this generates a logical ‘1’ signal. The respective outputs of the inverse bit-wise AND circuitry 401 and the bit-wise AND circuitry 403 provide the inputs to the logical AND circuitry 404. Thus, when both are a logical ‘1’ signal, this generates an output logical ‘1’ signal. If present, this logical ‘1’ signal as the input to the adjustment circuitry 405 causes the adjustment circuitry 405 to generate an adjusted shifted mantissa value. The adjustment circuitry 405 may receive the output of the shift circuitry 402 as an input (indicated as optional by the dashed line). In other words, the adjustment circuitry 405 may explicitly operate on the output of the shift circuitry 402. Alternatively the adjustment circuitry 405 may directly generate the adjusted mantissa (e.g. by generating a set bit in the least significant bit position).

FIG. 5 schematically illustrates a process of fabrication of an apparatus comprising floating point arithmetic circuitry in accordance with some examples. As shown, a non-transitory computer-readable medium 500 is provided on which is stored computer-readable code defining the configuration of an apparatus according to the present techniques. Physical generation of such an apparatus may then take place via a multi-stage production process of which only a high-level overview is given in FIG. 5, in which the computer-readable medium 500 provides an input to electronic design automation (EDA) stage 501 at which integrated circuitry is designed and laid out. Thus defined, the subsequent stage shown is the fabrication stage 502, resulting in the apparatus 503 embodying the present techniques.

FIG. 6 is a flow diagram showing a sequence of steps which are taken when carrying out a method in accordance with some examples. The flow starts at step 600 at which there is a combined arithmetic operation to be performed on a first floating point value, a second floating point value, and a third floating point value. Then in the first operational step 601, a rounded first arithmetic operation is performed in the first floating point value and the second floating point value. Next at step 602, the sum of the first and second floating point value exponents is compared with the third floating point value exponent. This determines whether the combined arithmetic operation will be first arithmetic operation dominated or second arithmetic operation dominated. In the latter case the flow proceeds directly to the final step 606 where the rounded second arithmetic operation is performed and the flow concludes. However in the case that the combined arithmetic operation is first arithmetic operation dominated, the flow proceeds from step 602 to step 603 at which a shift is applied to the third floating point value mantissa (in order to correctly align it with the result of the first arithmetic operation prior to the second arithmetic operation). It is then determined at step 604 if this third floating point value mantissa was non-zero and has been caused to become zero by the result of the shift operation. If this is not the case the flow proceeds directly to step 606. However when this is the case then the flow proceeds via step 605 at which the zero value shifted mantissa is adjusted to be non-zero. It may for example be incremented to provide a minimum value representable. Then, the flow proceeds to step 606 for the rounded second arithmetic operation to be carried out.

Concepts described herein may be embodied in a system comprising at least one packaged chip. The apparatus or circuitry described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

As shown in FIG. 7, one or more packaged chips 700, with the apparatus or circuitry described above implemented on one chip or distributed over two or more of the chips, are manufactured by a semiconductor chip manufacturer. In some examples, the chip product 700 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 700 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 700 are assembled on a board 702 together with at least one system component 704 to provide a system 706. For example, the board may comprise a printed circuit board. The board substrate may be made of any of a variety of materials, e.g. plastic, glass, ceramic, or a flexible substrate material such as paper, plastic or textile material. The at least one system component 704 comprise one or more external components which are not part of the one or more packaged chip(s) 700. For example, the at least one system component 704 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 716 is manufactured comprising the system 706 (including the board 702, the one or more chips 700 and the at least one system component 704) and one or more product components 712. The product components 712 comprise one or more further components which are not part of the system 706. As a non-exhaustive list of examples, the one or more product components 712 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 706 and one or more product components 712 may be assembled on to a further board 714.

The board 702 or the further board 714 may be provided on or within a device housing or other structural support (e.g. a frame or blade) to provide a product which can be handled by a user and/or is intended for operational use by a person or company.

The system 706 or the chip-containing product 716 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

In brief overall summary, an apparatus, a computer-readable medium, a system, a chip-containing product and a method are provided relating to floating point arithmetic, wherein a combined arithmetic operation with respect to three input floating point values is performed. The combined arithmetic operation comprises a rounded first arithmetic operation on the first and second input floating point values generating a rounded first arithmetic result and a rounded second arithmetic operation on the rounded first arithmetic result and the third input floating point value to generate a final rounded result of the combined arithmetic operation. When a shift operation on a non-zero mantissa of the third input floating point value generates a zero-value shifted mantissa, the zero-value shifted mantissa is adjusted to become non-zero.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments have been described in detail herein with reference to the accompanying drawings, it is to be understood that the invention is not limited to those precise embodiments, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

1. Apparatus comprising:
floating point arithmetic circuitry configured to perform a combined arithmetic operation with respect to a first input floating point value, a second input floating point value, and a third input floating point value,
wherein the combined arithmetic operation comprises:
a rounded first arithmetic operation on the first input floating point value and the second input floating point value to generate a rounded first arithmetic result; and
a rounded second arithmetic operation on the rounded first arithmetic result and the third input floating point value to generate a final rounded result of the combined arithmetic operation,
wherein, when the combined arithmetic operation is first arithmetic operation dominated, the floating point arithmetic circuitry is configured to perform a shift operation on a mantissa of the third input floating point value based on an exponent difference between summed exponents of the first and second input floating point values and an exponent of the third input floating point value,
wherein the floating point arithmetic circuitry further comprises sticky-bit preservation circuitry configured to apply a sticky-bit preservation to the shift operation, wherein the sticky-bit preservation comprises:
for a non-zero mantissa of the third input floating point value, when the shift operation on the mantissa of the third input floating point value generates a zero-value shifted mantissa, adjusting the zero-value shifted mantissa to become non-zero.

2. The apparatus as claimed in claim 1,
wherein the sticky-bit preservation circuitry comprises:
bit-wise-AND circuitry configured to determine whether the mantissa of the third input floating point value is a non-zero value;
bit-wise-AND circuitry configured to determine whether the shift operation on the mantissa of the third input floating point value generates a zero value; and
output adjustment circuitry configured to adjust the zero-value shifted mantissa to become non-zero.

3. The apparatus as claimed in claim 2,
wherein the output adjustment circuitry is configured to increment the zero-value shifted mantissa.

4. The apparatus as claimed in claim 1,
wherein the combined arithmetic operation is a chained multiply-add operation,
wherein the rounded first arithmetic operation is a rounded multiplication, and
wherein the rounded second arithmetic operation is a rounded addition.

5. The apparatus as claimed in claim 1, further comprising:
instruction decoding circuitry configured to decode program instructions and to generate control signals to control the floating point arithmetic circuitry to perform floating point arithmetic operations represented by the program instructions,
wherein the instruction decoding circuitry is configured to decode a sticky-bit-preserving shift instruction and to generate control signals which cause the sticky-bit preservation circuitry to apply the sticky-bit preservation to the shift operation.

6. A non-transitory computer-readable medium on which is stored computer-readable code for fabrication of an apparatus as claimed in claim 1.

7. A system comprising:
the apparatus of claim 1, implemented in at least one packaged chip;
at least one system component; and
a board,
wherein the at least one packaged chip and the at least one system component are assembled on the board.

8. A chip-containing product comprising the system of claim 7 assembled on a further board with at least one other product component.

9. A method of operating floating point arithmetic circuitry comprising:
performing a combined arithmetic operation with respect to a first input floating point value, a second input floating point value, and a third input floating point value, wherein the combined arithmetic operation comprises:
performing a rounded first arithmetic operation on the first input floating point value and the second input floating point value to generate a rounded first arithmetic result;
performing a rounded second arithmetic operation on the rounded first arithmetic result and the third input floating point value to generate a final rounded result of the combined arithmetic operation;
when the combined arithmetic operation is first arithmetic operation dominated, performing a shift operation on a mantissa of the third input floating point value based on an exponent difference between summed exponents of the first and second input floating point values and an exponent of the third input floating point value; and
applying a sticky-bit preservation to the shift operation, wherein the sticky-bit preservation comprises:
for a non-zero mantissa of the third input floating point value, when the shift operation on the mantissa of the third input floating point value generates a zero-value shifted mantissa, adjusting the zero-value shifted mantissa to become non-zero.

10. The method as claimed in claim 9,
wherein the sticky-bit preservation comprises:
using bit-wise-AND circuitry to determine whether the mantissa of the third input floating point value is a non-zero value;
using bit-wise-AND circuitry to determine whether the shift operation on the mantissa of the third input floating point value generates a zero value.

11. The method as claimed in claim 9,
wherein adjusting the zero-value shifted mantissa comprises incrementing the zero-value shifted mantissa.

12. The method as claimed in claim 9,
wherein the combined arithmetic operation is a chained multiply-add operation,
wherein the rounded first arithmetic operation is a rounded multiplication, and
wherein the rounded second arithmetic operation is a rounded addition.

13. The method as claimed in claim 9, further comprising:
using instruction decoding circuitry to decode program instructions and to generate control signals to control floating point arithmetic circuitry to perform floating point arithmetic operations represented by the program instructions,
wherein decoding the program instructions comprises decoding a sticky-bit-preserving shift instruction and generating control signals which cause the application of the sticky-bit preservation to the shift operation.
